(19) United States
(12) Patent Application Publication
(10) Pub. No.: US 2006/0188681 A1
(43) Pub. Date: Aug. 24, 2006

(54) Grip belt

(75) Inventor: Jack Wang, Taichung Hsien (TW)

Correspondence Address: BACON & THOMAS, PLLC, 625 SLATERS LANE, FOURTH FLOOR, ALEXANDRIA, VA, 22314, US

(73) Assignee: HIGH CEDAR ENTERPRISE CO., LTD., TAICHUNG HSIEN (TW)

(21) Appl. No.: 11/130,097

(22) Filed: May 17, 2005

(30) Foreign Application Priority Data
Feb. 22, 2005 (TW) 94202817

(51) Int. Cl. B32B 33/00

(52) U.S. Cl. 428/40.1

(57) ABSTRACT

A grip belt includes a belt body, a protective film separatably covered on the belt body, and a sticker having a top surface and a bottom surface. The bottom surface of the sticker has a bonding area covered with an adhesive and bonded to a rear end of the protective film and a clean area suspended outside the protective film for pulling by a user to separate the protective film from the belt body.

### BACKGROUND OF THE INVENTION

1. Field of the Invention

The present invention relates to a grip for sports apparatus and more particularly, to a grip belt for wound round the handle of a sports apparatus.

2. Description of the Related Art

The so-called grip belt is a belt for wound round the handle of a sports apparatus, for example, a tennis racket, badminton racket, or golf club, or the handle of a vehicle, for example, bicycle or kick scooter. Elastic polymers, polyurethane (PU), Ethylene Vinyl Acetate (EVA), rubber, etc. are commonly used for making grip belts. A grip belt of compound materials may have one single layer or multiple layers, giving a comfortable gripping and, providing anti-slipping, shock absorbing, sweat expelling, and breathing effects.

When grip belts are produced, they are stored in warehouses or delivered to distributors for selling to consumers. During storage, the surface of each grip belt must be well protected against oxidation, aging, or contamination. Improper storage condition results in defectiveness of the product.

As shown in FIG. 1, the surface of a conventional single-layer belt body 1 is covered with a thin-layer of protective film 2 for protection. Because the protective film 2 has a thin thickness and is fully bonded to the surface of the belt body 1, it is difficult to separate the protective film 2 from the belt body 1 with the fingernail. Forcing the protective film 2 away from the belt body 1 with the fingernail by force may damage or permanently deform the belt body. FIG. 2 shows another structure of belt grip according to the prior art. According to this design, the belt body 1 is covered with a protective film 2, and a sticker 3 is bonded to one end of the protective film 2 to indicate the strippable end of the protective film 2. The sticker 3 is simply used to indicate the location of the end of the protective film 2, however it does no help to the operation of stripping off the protective film 2 from the belt body 1.

### SUMMARY OF THE INVENTION

The present invention has been accomplished under the circumstances in view. It is one object of the present invention to provide a grip belt, which allows quick separation of the protective film from the belt body thereof.

It is another object of the present invention to provide a grip belt, which prevents damage to the belt body during separation of the protective film.

To achieve these objects of the present invention, the grip belt comprises a belt body, a protective film separatably covered on the belt body, and a sticker fastened to the protective film. The sticker has a top surface and a bottom surface that has a bonding area covered with an adhesive and bonded to the protective film and a clean area suspended outside the protective film for pulling by the user to separate the protective film from the belt body.

### BRIEF DESCRIPTION OF THE DRAWINGS

FIG. 1 is a perspective view of a grip belt according to the prior art.

FIG. 2 is a perspective view of another structure of grip belt according to the prior art.

FIG. 3 is an exploded view of a grip belt according to the present invention.

FIG. 4 is an assembly view of the grip belt according to the present invention.

FIG. 5 is a side view in an enlarged scale of the grip belt according to the present invention.

FIG. 6 is a schematic drawing showing the stripping operation of the present invention.

FIGS. 7A-7C are schematic drawings showing the manufacturing steps of the present invention.

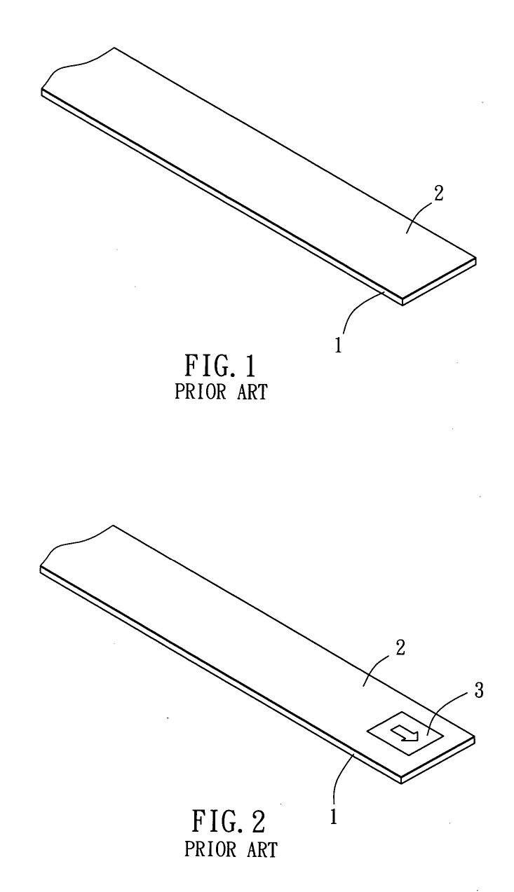

### DETAILED DESCRIPTION OF THE INVENTION

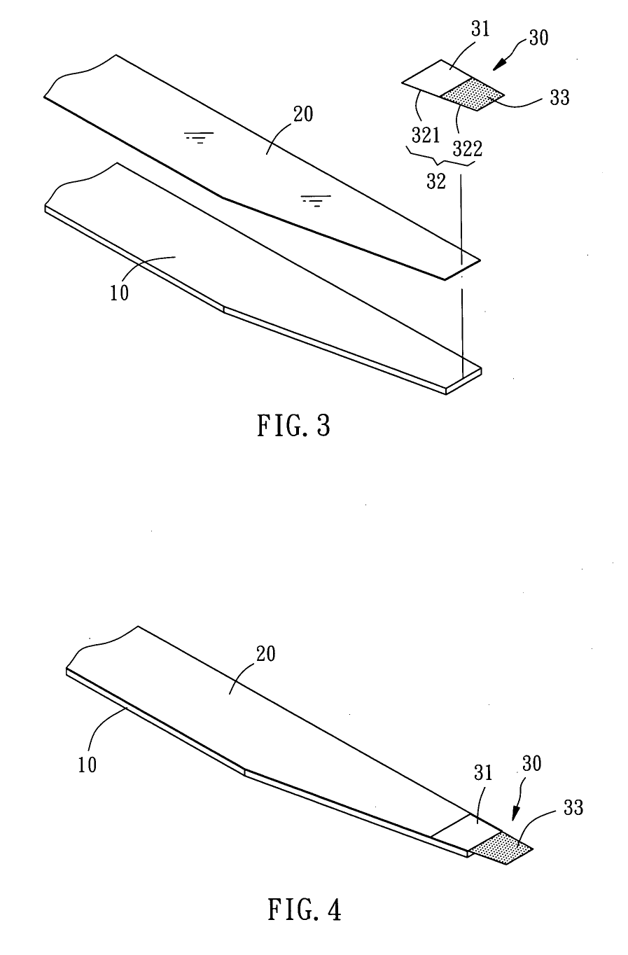

Referring to FIGS. 3-5, a grip belt in accordance with the present invention is shown comprising a belt body 10, a protective film 20, and a sticker 30. The protective film 20 is adhered to the top surface of the belt body 10 to protect the belt body 10 against scratch or contamination or to isolate the belt body 10 from outside open air, preventing oxidation or aging of the belt body 10.

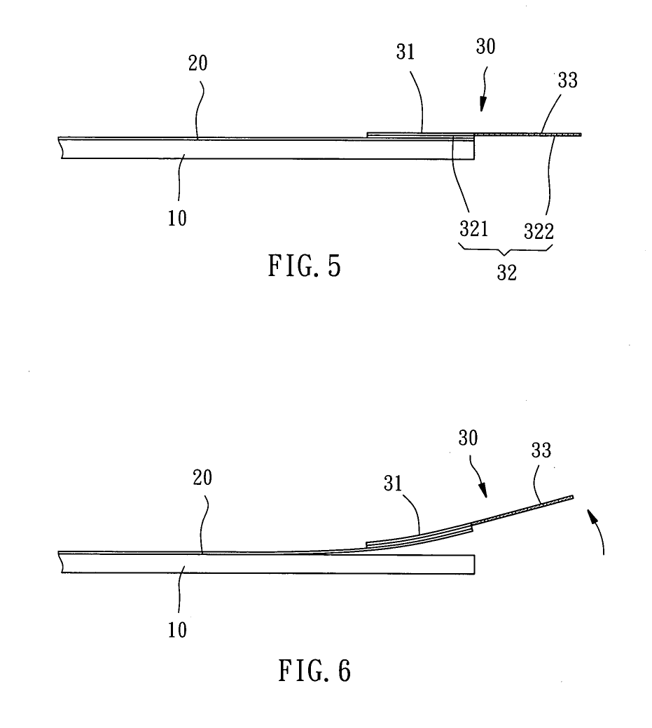

The sticker 30 has a top surface 31 and a bottom surface 32. The bottom surface 32 of the sticker 30 has a bonding area 321 and a clean area 322. The bonding area 321 is covered with a layer of adhesive and partially or wholly adhered to one end, namely, the rear end of the protective film 20, leaving the clean area 322 suspended beyond the rear end of the protective film 20. Because the clean area 322 is not covered with an adhesive, it will not be adhered to the protective film 20. Therefore, the clean area 322 is stiffly suspended beyond the rear end of the protective film 30 for pulling by the user to separate the protective film 20 from the belt body 10 (see FIG. 5). Further, the sticker 30 has an indication area 33 that is colored with a color different from the color of the surface of belt body 10 to provide a strong color contrast at the stripping point where the user can easily strip off the protective film 20 from the belt body 10. The indication area 33 is preferably at the top side of the clean area 322 of the sticker 30.

The stripping operation is easy and outlined hereinafter with reference to FIG. 6. At first, find the stripping point, and then strip off the protective film 20 from the belt body 10. By means of color difference between the indication area 33 of the sticker 30 and the belt body 1, the user can quickly find the stripping point. When stripping the protective film 20 from the belt body 10, pull the clean area 32 of the sticker 30 with the fingers in one direction contra the belt body 10. Because the bonding area 321 of the sticker 30 is adhered to the rear end of the protective film 20, pulling the clean area 322 with the fingers will separate the protective film 20 from the belt body 10.

Further, because the grip belt is to be wound round a handle in a spiral manner, the rear end of the grip belt is made gradually smaller, forming a slant side edge. This design enables the grip belt to be fastened to a handle smoothly without protrusion. In actual practice, the sticker 30 is preferably bonded to the rear end of the grip belt.

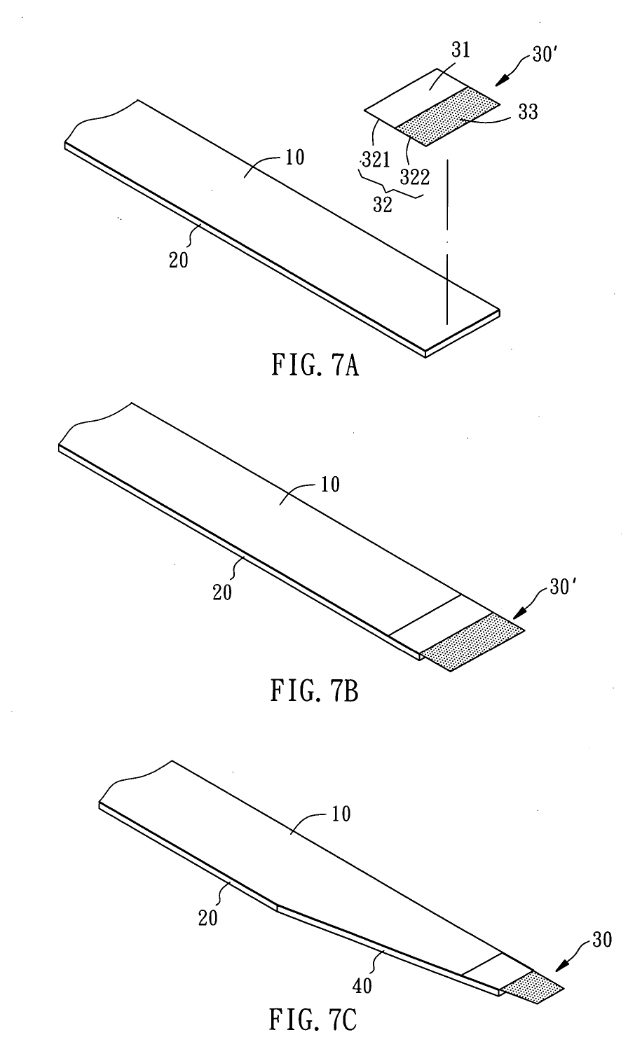

FIGS. 7A-7C show the manufacturing steps of the grip belt. At first, a belt body 10 and a protective film 20 are prepared to have same width, and then the belt body 10 and the protective film 20 are bonded together as shown in FIG. 7A, and then a sticker 30 is prepared to have the same width and bonded to the rear end of the protective film 20 as shown in FIG. 7B, and then the assembly of the belt body 10 and the protective film 20 and the sticker 30 are properly cut to provide a slant side edge 40. When finished, the belt body 10, the protective film 20 and the sticker 30 have a respective slant side edge, and the slant side edges of the belt body 10, the protective film 20 and the sticker 30 are disposed in flush with one another, showing a unitary sense of beauty.

As indicated above, the invention provides a grip belt that has a sticker at one end thereof to indicate the stripping point and to let the user strip off the protective film easily.

What is claimed is:

1. A grip belt comprising a belt body, a protective film separatably covered on said belt body, and a sticker fastened to said protective film, wherein said sticker has a top surface and a bottom surface, the bottom surface of said sticker having a bonding area covered with an adhesive and bonded to said protective film and a clean area suspended outside said protective film for pulling by the user to separate said protective film from said belt body.

2. The grip belt as claimed in claim 1, wherein said bonding area of said sticker has at least one part bonded to a rear end of said protective film.

3. The grip belt as claimed in claim 1, wherein said sticker has a side edge disposed in flush with the said protective film.

4. The grip belt as claimed in claim 1, wherein said sticker has an indication area, said indication area having a color different from the color of said belt body.

5. The grip belt as claimed in claim 4, wherein said indication area is disposed at a top side of said clean area of said sticker.
